(19) United States
(12) Patent Application Publication
(10) Pub. No.: US 2015/0292120 A1
(43) Pub. Date: Oct. 15, 2015

(54) APPARATUS AND METHODS FOR PRODUCING FIBERS FROM PROTEINS

(71) Applicants: Randolph V. Lewis, Nibley, UT (US); Justin A. Jones, Nibley, UT (US); Cameron G. Copeland, Logan, UT (US)

(72) Inventors: Randolph V. Lewis, Nibley, UT (US); Justin A. Jones, Nibley, UT (US); Cameron G. Copeland, Logan, UT (US)

(73) Assignee: Utah State University, North Logan, UT (US)

(21) Appl. No.: 14/681,951

(22) Filed: Apr. 8, 2015

Related U.S. Application Data
(60) Provisional application No. 61/977,552, filed on Apr. 9, 2014.

(51) Int. Cl. D01F 11/02; B29C 47/00; D01B 7/00

(52) U.S. Cl. CPC D01F 11/02; D01B 7/00; B29C 47/0004; B29K 2089/00; B29L 2031/731

(57) ABSTRACT

Methods and apparatuses for preparing protein fibers (biofilaments) from recombinant biofilament proteins are disclosed. The methods are particularly useful for spinning fibers of spider silk or silkworm silk proteins from recombinant sources and may be used to spin such fibers for use in the manufacture of industrial and commercial products.

### CROSS-REFERENCE TO RELATED APPLICATIONS

This application claims priority to U.S. Provisional Patent Application No. 61/977,552 filed on Apr. 9, 2014, the entirety of which is hereby incorporated by reference.

### BACKGROUND OF THE INVENTION

1. Field of the Invention

The present disclosure relates to methods and devices for preparing proteins into fibers, and is particularly useful for spinning recombinant silk proteins and enhancing the physical properties of the resultant fibers.

2. Description of the Related Art

Spider silks and other natural silks are proteinaceous fibers composed largely of non-essential amino acids. Orb-web spinning spiders have as many as seven sets of highly specialized glands that produce up to seven different types of silk. Each silk protein has a different amino acid composition, mechanical property, and function. The physical properties of a silk fiber are influenced by the amino acid sequence, spinning mechanism, and environmental conditions in which they are produced.

Dragline spider silk is among the strongest known biomaterials. It is the silk used for the framework of a spider web and used to catch the spider if it falls. For example, the dragline silk of A. diadematus demonstrates high tensile strength (1.9 Gpa; ˜15 gpd) approximately equivalent to that of steel (1.3 Gpa) and synthetic fibers such as aramid fibers (e.g., Kevlar™). Dragline silk is made of two proteins, Major Ampullate Spider Proteins 1 and 2 (MaSp1 and MaSp2).

The physical properties of dragline silk balance stiffness and strength, both in extension and compression, imparting the ability to dissipate kinetic energy without structural failure. Due to their desirable mechanical properties, proteinaceous fibers and silks may be desirable for new biomaterials, drug delivery, tendon and ligament repair, as well as athletic gear, military applications, airbags, and tire cords among others.

The utility of silk proteins as “super filaments” has led to attempts to produce these silks in large quantities. Many of the creatures that produce proteinaceous fibers, however, cannot be farmed, for example spiders are territorial and cannibalistic. Methods of mass-producing synthetic silks have been developed including transgenic animals, plants, as well as recombinant techniques. Previous efforts at generating commercial fibers from silk proteins have been limited, with particular problems evident in maintaining stability, integrity, and workability of the fibers as well as scaling their production. The methods and apparatus disclosed herein offer innovative solutions to these problems culminating in the result of production of uniform and stable commercially viable quantities of silk fibers, including recombinant silk fibers.

### SUMMARY OF THE INVENTION

In one aspect, an apparatus for producing silk fibers is disclosed and includes: an extruder; a first coagulation bath; an adjustable, mounting frame; a plurality of rollers located on the frame; a first stretch bath located between at least two rollers.

In some embodiments, the plurality of rollers includes a first set of rollers comprising at least three rollers, wherein each roller is located on the frame; and a second set of rollers comprising at least three rollers, wherein each roller is located on the frame. In some embodiments, the apparatus includes a second stretch bath.

In some embodiments, the apparatus includes one or more monitoring devices for inspecting properties of silk fibers passing by the one or more monitoring devices. In some embodiments, the apparatus includes a spool onto which fibers passing through the apparatus may be wound. In some embodiments, the apparatus includes one or more heat lamps.

In some embodiments, at least two rollers are immersed in a stretch bath. In some embodiments, each roller has a drum surface, and at least one roller has a v-shaped drum surface. In some embodiments, the apparatus includes a plurality of motors, each motor connected to a roller. In some embodiments, the apparatus includes a spinning control capable of regulating the rotating speed of one roller relative to another roller.

In another aspect, a method of making a silk fiber is disclosed, and includes: extruding a spin dope comprising recombinant silk protein into a coagulation bath comprising an organic alcohol to form a silk fiber; winding the fiber through a plurality of adjustable rollers and a first stretch bath, wherein the a first set of rollers introduces the silk fiber into the stretch bath and a second set of rollers removes the silk fiber from the stretch bath, and wherein the rollers may be adjustably located relative to one another on an adjustable, mounting frame; stretching the silk fiber in the stretch bath by rotating one of the rollers faster than another roller.

In some embodiments, the plurality of rollers includes a first set three rollers and a second set of three rollers. In some embodiments, the silk protein is a recombinant spider silk protein. In some embodiments, the method includes stretching the silk fiber in a second stretch bath. In some embodiments, the method includes monitoring physical characteristics of the silk fiber. In some embodiments, the method includes collecting the fiber onto a spool. In some embodiments, the method includes heating the fiber with one or more heat lamps.

In some embodiments, the method includes using a spinning control capable of regulating the rotating speed of one roller relative to another roller. In some embodiments, the method includes air-stretching the silk fiber.

In some embodiments, the coagulation bath further includes a coagulating agent selected from an organic alcohol, high salt aqueous solution, and mixtures of the same. In some embodiments, the first stretch bath includes one or more of: an organic alcohol, aqueous salt, and mixtures of the same. In some embodiments, the second stretch bath comprises one or more of: an organic alcohol, aqueous salt, and mixtures of the same.

### BRIEF DESCRIPTION OF THE DRAWINGS

FIG. 1 shows a layout of components using one embodiment of the invention.

FIG. 2 shows an alternate layout of components using one embodiment of the invention.

FIG. 3 shows an alternate layout of components using one embodiment of the invention.

FIG. 4 shows a v-shaped roller which may be used in some embodiments of the invention.

### DETAILED DESCRIPTION

### Definitions of Terms

In this specification and the claims that follow, singular forms such as “a,” “an,” and “the” include plural forms unless the content clearly dictates otherwise. All ranges disclosed herein include, unless specifically indicated, all endpoints and intermediate values. In addition, “optional” or “optionally” refer, for example, to instances in which subsequently described circumstance may or may not occur, and include instances in which the circumstance occurs and instances in which the circumstance does not occur. The terms “one or more” and “at least one” refer, for example, to instances in which one of the subsequently described circumstances occurs, and to instances in which more than one of the subsequently described circumstances occurs.

As used herein, the phrases “dope solution” or “spin dope” means any liquid mixture that contains silk protein and is amenable to extrusion for the formation of a biofilament or film casting. Dope solutions may also contain, in addition to protein monomers, higher order aggregates including, for example, dimers, trimers, and tetramers. Normally, dope solutions are aqueous solutions of between pH 4.0 and 12.0 and having less than 40% organics or chaotropic agents (w/v). In some embodiments, the dope solutions do not contain any organic solvents or chaotropic agents, yet may include additives to enhance preservation, stability, or workability of the solution. Dope solutions may be made by purifying and concentrating a biological fluid from a transgenic organism that expresses a recombinant silk protein. Suitable biological fluids include, for example, cell culture media, milk, urine, or blood from a transgenic mammal, cultured bacteria, and exudates or extracts from transgenic plants.

As used herein, the term “filament” means a fiber of indefinite length, ranging from microscopic length to lengths of a mile or greater. Silk is a natural filament, while nylon and polyester are synthetic filaments.

As used herein, the term “biofilament” means a filament created (e.g., spun) from a protein, including recombinantly produced silk proteins.

As used herein, the term “plasticizer” means a chemical added to polymers and resins to impart flexibility or stretchability, or a bonding agent that acts by solvent action on fibers. Water may act as a plasticizer, and a plasticizer means other substances which, owing to their intrinsic characteristics or by aiding in water retention, improve the ductility and plasticity of a fiber.

As used herein, the term “toughness” refers to the energy needed to break the fiber or filament. This is the area under the force elongation curve, sometimes referred to as “energy to break” or work to rupture.

As used herein, the term “elasticity” refers to the property of a body which tends to recover its original size and shape after deformation. Plasticity, deformation without recovery, is the opposite of elasticity. On a molecular configuration of the textile fiber, recoverable or elastic deformation is possible by stretching (reorientation) of inter-atomic and inter-molecular structural bonds. Conversely, breaking and re-forming of intermolecular bonds into new stabilized positions causes non-recoverable or plastic deformations.

As used herein, the term “extension” refers to an increase in length expressed as a percentage or fraction of the initial length.

As used herein, the term “fineness” means the mean diameter of a fiber (e.g., a biofilament), which is usually expressed in microns (micrometers).

As used herein, the term “micro fiber” means a filament having a fineness of less than 1 denier.

As used herein, the term “modulus” refers to the ratio of load to corresponding strain for a fiber, yarn, or fabric.

As used herein, the term “orientation” refers to the molecular structure of a filament or the arrangement of filaments within a thread or yarn, and describes the degree of parallelism of components relative to the main axis of the structure. A high degree of orientation in a thread or yarn is usually the result of a combing or attenuating action of the filament assemblies. Orientation in a fiber is the result of shear flow elongation of molecules.

As used herein, the term “spinning” refers to the process of making filament or fiber by extrusion of a fiber forming substance, drawing, twisting, or winding fibrous substances.

As used herein, the term “tenacity” or “tensile strength” refers to the amount of weight a filament can bear before breaking The maximum specific stress that is developed is usually in the filament, yarn or fabric by a tensile test to break the materials.

As used herein, the term “substantially pure” is meant substantially free from other biological molecules such as other proteins, lipids, carbohydrates, and nucleic acids. Typically, a dope solution is substantially pure when at least 60%, more preferably at least 75%, even more preferably 85%, most preferably 95%, or even 99% of the protein in solution is silk protein, on a wet weight or a dry weight basis. Further, a dope solution is substantially pure when proteins account for at least 60%, more preferably at least 75%, even more preferably 85%, most preferably 95%, or even 99% by weight of the organic molecules in solution.

### Silk Proteins Suitable for Spinning

A variety of silk proteins can be used in the processes described herein. They include proteins from plant and animal sources, as well as recombinant and other cell culture source such as bacterial cultures. Such proteins may include sequences conventionally known for silk proteins (see for example, U.S. Pat. No. 7,288,391, incorporated herein by reference in its entirety).

Biofilament proteins may be derived from conditioned media recovered from eukaryotic cell cultures, such as mammalian cell cultures, which have been engineered to produce the desired biofilaments as secreted proteins. Cell lines capable of producing the subject proteins can be obtained by cDNA cloning, or by the cloning of genomic DNA, or a fragment thereof, from a desired cell. Examples of mammalian cell lines useful for the practice of the invention include, but are not limited to BHK (baby hamster kidney cells), CHO (Chinese hamster ovary cells) and MAC-T (mammary epithelial cells from cows).

The biofilament proteins that may be spun into filaments may be from several recombinant sources. Examples of such proteins recombinantly expressed include those identified in U.S. Patent Application Nos. 61/707,571; 14/042,183; PCT/US2013/062722; 61/865,487; and 61/917,259 that are incorporated herein by reference in their entirety, including recombinantly produced major ampullate, minor ampullate, flagelliform, tubuliform, aggregate, aciniform and pyriform proteins. These proteins may be any type of biofilament proteins such as those produced by a variety of arachnids including, for example, Nephilla clavipes, Arhaneus ssp. and A. diadematus. Also suitable for use in the invention are proteins produced by insects such as Bombyx mori. Dragline silk produced by the major ampullate gland of Nephilia clavipes occurs naturally as a mixture of at least two proteins, designated as MaSpI and MaSpII. Similarly, dragline silk produced by A. diadematus is also composed of a mixture of two proteins, designated ADF-3 and ADF-4.

The biofilament proteins spun as described herein may be monomeric proteins, fragments thereof, or dimers, trimers, tetramers or other multimers of a monomeric protein. The biofilament proteins are encoded by nucleic acids, which can be joined to a variety of expression control elements, including tissue-specific animal or plant promotors, enhancers, secretory signal sequences and terminators. These expression control sequences, in addition to being adaptable to the expression of a variety of gene products, afford a level of control over the timing and extent of production.

Suitable proteins for spinning into filaments may be extracted from mixtures comprising biological fluids produced by transgenic animals, such as transgenic mammals, including goats. Such animals have been genetically modified to secrete a target biofilament in, for example, their milk or urine (see for example, U.S. Pat. No. 5,907,080; WO 99/47661 and U.S. patent publication Ser. No. 20010042255, all of which are incorporated herein by reference). The biological fluids produced by the transgenic animals may be purified, clarified, and concentrated, through such techniques as, for example, tangential flow filtration, salt-induced precipitation, acid precipitation, EDTA-induced precipitation, and chromatographic techniques, including expanded bed absorption chromatography (see for example U.S. patent application Ser. No. 10/341,097, entitled Recovery of Biofilament Proteins from Biological Fluids, filed Jan. 13, 2003, incorporated herein by reference in its entirety).

The biofilaments may originate from plant sources. Several methods are known in the art by which to engineer plant cells to produce and secrete a variety of heterologous polypeptides (see for example, Esaka et al., Phytochem. 28:2655 2658, 1989; Esaka et al., Physiologia Plantarum 92:90 96, 1994; and Esaka et al, Plant Cell Physiol. 36:441 446, 1995, and Li et al., Plant Physiol. 114:1103 1111). Transgenic plants have also been generated to produce spider silk (see for example Scheller et al., Nature Biotech. 19:573, 2001; PCT publication WO 01/94393 A2).

Exudates produced by whole plants or plant parts may be used. The plant portions can be intact and living plant structures. These plants materials may be a distinct plant structure, such as shoots, roots or leaves. Alternatively, the plant portions may be part or all of a plant organ or tissue, provided the material contains or produces the biofilament protein to be recovered.

Having been externalized by the plant or the plant portion, exudates are readily obtained by any conventional method, including intermittent or continuous bathing of the plant or plant portion (whether isolated or part of an intact plant) with fluids. Exudates can be obtained by contacting the plant or portion with an aqueous solution such as a growth medium or water. The fluid-exudate admixture may then be subjected to the purification methods of the present invention to obtain the desired biofilament protein. The proteins may be recovered directly from a collected exudate, such as a guttation fluid, or a plant or a portion thereof.

Extracts may be derived from any transgenic plant capable of producing a recombinant biofilament protein. Plant species representing different plant families, including, but not limited to, monocots such as ryegrass, alfalfa, turfgrass, eelgrass, duckweed and wilgeon grass; dicots such as tobacco, tomato, rapeseed, azolla, floating rice, water hyacinth, and any of the flowering plants may be used. Other useful plant sources include aquatic plants capable of vegetative multiplication such as Lemna, and duckweeds that grow submerged in water, such as eelgrass and wilgeon grass. Water-based cultivation methods such as hydroponics or aeroponics are useful for growing the transgenic plants of interest, especially when the silk protein is secreted from the plant's roots into the hydroponic medium from which the protein is recovered.

A. Spider Silk Proteins

Spider silk proteins are designated according to the gland or organ of the spider in which they are produced. Spider silks known to exist include major ampullate (MaSp), minor ampullate (MiSp), flagelliform (Flag), tubuliform, aggregate, aciniform, and pyriform spider silk proteins. Spider silk proteins derived from each organ are generally distinguishable from those derived from other synthetic organs by virtue of their physical and chemical properties. For example, major ampullate silk, or dragline silk, is extremely tough. Minor ampullate silk, used in web construction, has high tensile strength. An orb-web's capture spiral, in part composed of flagelliform silk, is elastic and can triple in length before breaking Tubuliform silk is used in the outer layers of egg-sacs, whereas aciniform silk is involved in wrapping prey and pyriform silk is laid down as the attachment disk.

Sequencing of spider silk proteins has revealed that these proteins are dominated by iterations of four simple amino acid motifs: (1) polyalanine (Alaₙ); (2) alternating glycine and alanine (GlyAla)ₙ; (3) GlyGlyXaa; and (4) GlyProGly(Xaa)ₙ, where Xaa represents a small subset of amino acids, including Ala, Tyr, Leu and Gln (for example, in the case of the GlyProGlyXaaXaa motif, GlyProGlyGlnGln is the major form). Spider silk proteins may also contain spacers or linker regions comprising charged groups or other motifs, which separate the iterated peptide motifs into clusters or modules.

In some embodiments, biofilament proteins that can be used include recombinantly produced MaSpI and MaSpII proteins; minor ampullate spider silk proteins; flagelliform silks; and spider silk proteins described in any of U.S. Pat. Nos. 5,989,894; 5,728,810; 5,756,677; 5,733,771; 5,994,099; 7,057,023; and U.S. Provisional Patent Application No. 60/315,529 (all of which are incorporated herein by reference).

The sequences of the spider silk proteins may have amino acid inserts or terminal additions, so long as the protein retains the desired physical characteristics. Likewise, some of the amino acid sequences may be deleted from the protein so long as the protein retains the desired physical characteristics. Amino acid substitutions may also be made in the sequences, so long as the protein possesses or retains the desired physical characteristics.

B. Mixtures of Sources and Alternative Proteins

In some embodiments, mixtures of biofilament proteins derived from synthetic and natural or sources may be used. The different proteins and polymers can be combined prior in the spin dope or combined post-extrusion. In some embodiments, fibers of animal or plant origin, such as wool, silk, collagen, and cellulosics, or synthetic fibers such as poyolefin fibers, polyesters, polyamides (i.e., nylons), fibers from liquid crystalline polymers (e.g., aramids), polyoxymethylene, polyacrylics (i.e., polyacrylonitrile), poly(phenylene sulfide), poly(vinyl alcohol), poly(ether ether ketone) (i.e., PEEK), poly[2,2′-(m-phenylene)-5,5′-bibenzimidazole] (i.e., PBI), poly(blycolic acid), poly(glycolic acid-co-L-lactic acid, and poly(L-lactide), aromatic polyhydrazides, aromatic polyazomethines, aromatic polyimides, poly(butene-1), polycarbonate, polystyrene, and polytetrafluoroethylene may be used.

Silkworm silk proteins may also be prepared. Silkworm silk proteins include those from Bombyx mori including H-chain and L-chain proteins and recombinant versions thereof.

### Spin Dope Preparation

Spin dopes may be created using 10-40% weight protein/volume solvent (w/v). Spin dopes may be created using a variety of solvents and mixtures. In some embodiments, the primary solvent is 1,1,1,3,3,3,-hexafluoro-2-proponal (HFIP) which may be augmented with additives such as formic acid, propionic acid, anhydrous toluene, acetic acid, and isopropanol. In some embodiments, HFIP is the predominant constituent making up between 70 and 100% of the total volume of a spin dope. In some embodiments, organic acids can also be included, using up to 15% of each, in order to make a spin dope. Examples of suitable organic acids include formic acid, acetic acid, and propionic acid. In some embodiments, water alone or with various additives as described above can be used.

For example, spider dragline silk is composed of two proteins major ampullate silk protein 1 (MaSp1) and major ampullate silk protein 2 (MaSp2). Naturally, Nephila clavipes uses a ratio of 80% MaSp1 and 20% MaSp2. Shortened versions of these proteins can be used, generated by genetically altered goats. For the creation of synthetic fibers, varying ratios of MaSp1-like and MaSp2-like protein can be used in spin dopes, from 0-100% of either can be used to make fibers with appreciable properties. Other components can be added to the spin dope for solvation, preservation, and to impart desirable physical characteristics.

To create the dopes, protein is placed in a glass vial. Solvents are then added, and the vials is placed on a motorized rotator and allowed to slowly mix. Formic acid dopes require approximately 12 hours to completely mix. Acetic acid dopes using 25-30% protein can take up to 3 days to completely dissolve. Once the protein is dissolved, impurities exist and can be removed by centrifugation. With the aqueous spin dopes heat and pressure are used to dissolve the protein (See Patent U.S. patent application Ser. No. 14/459,244, which is hereby incorporated by reference in its entirety, for details).

### Fiber Spinning

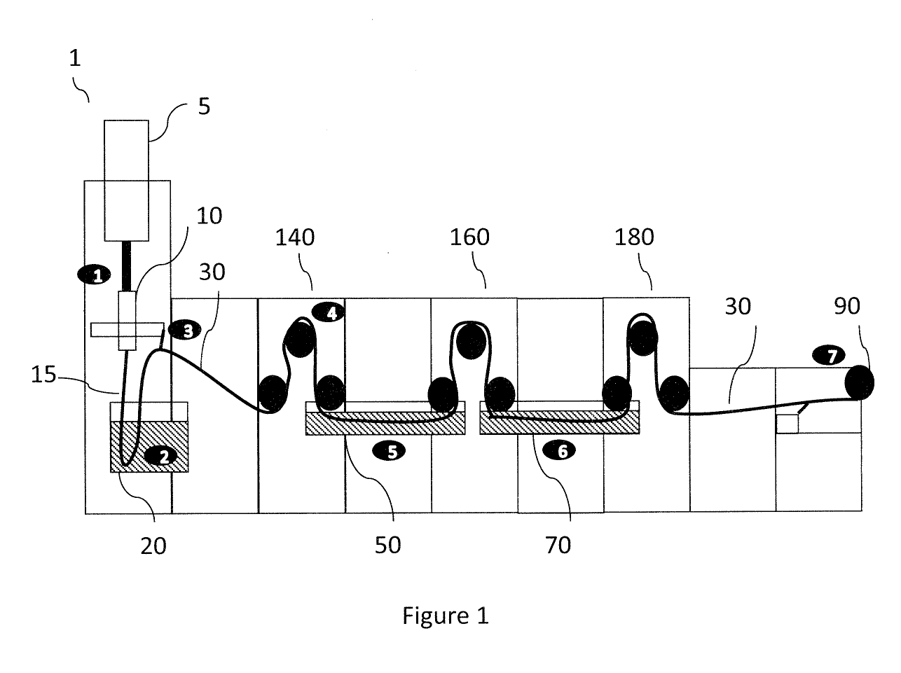

Fibers can be spun by extruding a spin dope into a coagulation bath followed by passing one or more filaments through a series of rollers, one or more stretch baths, weaving and or winding components for collection and subsequent use. Illustrative apparatus and processes are shown in FIGS. 1-3. Similar elements are numbered with similar numbering between the drawings.

Referring to FIG. 1, a system 1 for producing silk fibers is shown. The system includes a plunger 5 for forcing a spin dope solution through a spinneret 10 such as a spinneret plate. The spin dope solvent is removed from the extruded filament 30 as the extruded filament passes through an organic alcohol-containing coagulation bath 20.

The extruded filament 30 is oriented by stretching and extrusion. In some embodiments, the filaments are first extruded into a coagulation bath through an air gap. The air gap allows the filaments to undergo some stretching on the order of two to three times the strain (2-3-fold extension), which produces a high degree of molecular orientation which is sustained as the filament immerses into the coagulation bath. Alternatively and as shown in FIG. 1, the extruded filament 30 passes through a needle or tubing 15 and into coagulation bath 20.

A single or multiple fibers are guided to a series of rollers. For example, a first set of rollers 40 having three rollers enable further orientation of the fiber for introduction into a bath, such as stretch bath 50. The fiber passes through the bath and exits by passing around a second set of rollers 60. The second set of rollers guide the fiber to a second stretch bath 70. The fiber 30 passes through the second bath 70 and around a third set of rollers 80 to a winding spool 90.

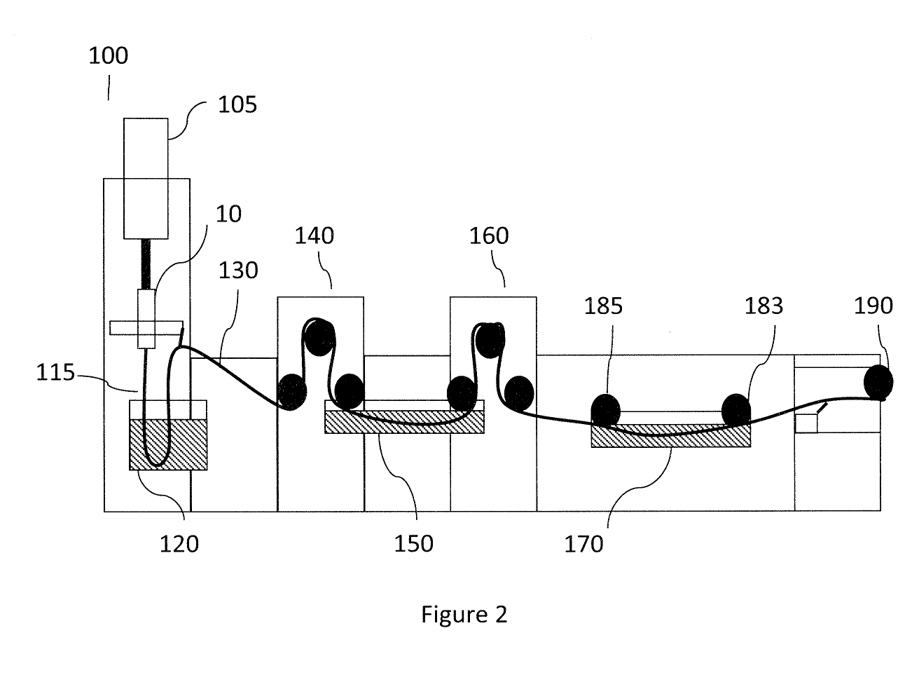

The number of rollers can vary depending on the number of stretches (whether air or bath stretches) that are desired. As shown in FIG. 2, an alternative arrangement of rollers is shown. Particularly, fiber 130 can be guided through a stretch bath 170 with rollers 183 and 185 that are immersed in the bath 170. In embodiments, immersion of rollers may be complete or partial.

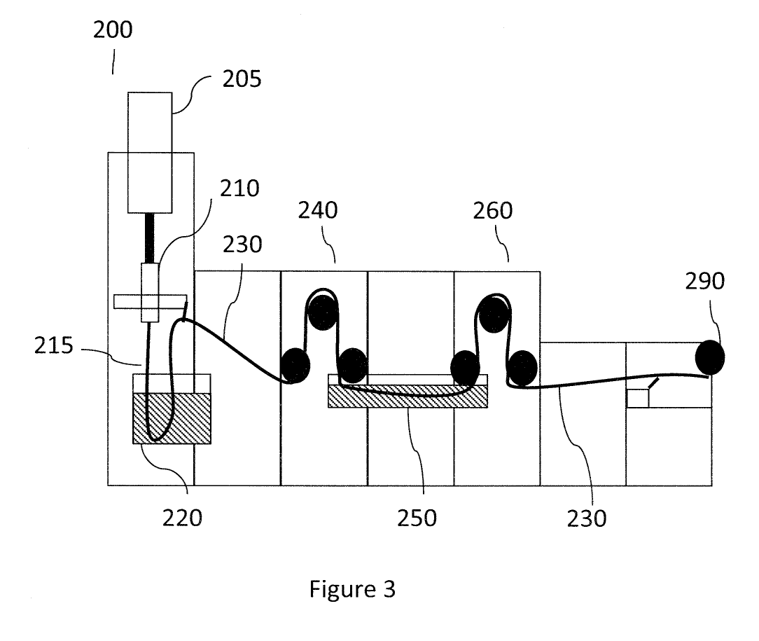

The number of stretch baths can vary. For example, as shown in FIG. 3, a system 200 is shown with a single stretch bath 250 through which fiber 230 passes between a first set of rollers 240 to a second set of rollers 260.

### Stretch Baths

As explained above, silk fibers are stretched in stretch baths between rollers operated at various speeds. In some embodiments, the stretch baths are aqueous that contain water, typically deionized water, and may optionally include other components. Optional components include organic alcohols and salts and mixtures of the same. Suitable alcohols include methanol, ethanol, n-propanol, isopropyl alcohol, n-butanol, sec-butanol, and tert-butyl alcohol and mixtures of the same. Suitable salts include ammonium sulfate, sodium sulfate, potassium sulfate and other highly charged salts. Other suitable salts include the alkaline, alkaline earth, and ammonium nitrate and phosphate salts and mixtures of the same.

In some embodiments, the aqueous, stretch bath consists of deionized water. In some embodiments, the aqueous, stretch bath consists of a saline solution. In some embodiments, the aqueous, stretch bath consists of a miscible mixture of water and methanol. In some embodiments, the aqueous, stretch bath consists of a miscible mixture of water and ethanol. In some embodiments, the aqueous, stretch bath consists of a miscible mixture of water and n-propanol. In some embodiments, the aqueous, stretch bath consists of a miscible mixture of water and isopropanol. In some embodiments, the aqueous, stretch bath consists of a miscible mixture of water and n-butanol. In some embodiments, the aqueous, stretch bath consists of a miscible mixture of water and sec-butanol. In some embodiments, the aqueous, stretch bath consists of a miscible mixture of water and tert-butanol.

In some embodiments, the proportion of alcohol present is less than or about 90% (for example 10% water, volume/volume). In some embodiments, the proportion is less than or about 80%. In some embodiments, the proportion is less than or about 70%. In some embodiments, the proportion is less than or about 60%. In some embodiments, the proportion is less than or about 50%. In some embodiments, the proportion is less than or about 40%. In some embodiments, the proportion is less than or about 35%. In some embodiments, the proportion is less than or about 30%. In some embodiments, the proportion is less than or about 25%. In some embodiments, the proportion is less than or about 20%. In some embodiments, the proportion is less than or about 15%. In some embodiments, the proportion is less than or about 10%. In some embodiments, the proportion is less than or about 5%. In some embodiments, the proportion is less than or about 1%.

The amount of alcohol or salt present in each aqueous, stretch bath may vary between baths. In some embodiments, the proportions of organic alcohol and/or salt in each stretch bath are the same. In some embodiments having a plurality of stretch baths, the baths may have varying proportions of organic alcohol and/or salt in some or all of the baths.

In some embodiments, the stretch baths may consist of any of the aforementioned organic alcohols and mixtures of the same and be substantially free of water.

In some embodiments, the stretch baths are heated. In some embodiments, the fibers are heated under a heat lamp before entering a stretch bath. In some embodiments, the fibers are heated under a heat lamp after exiting a stretch bath.

### Stretching

Stretching of the fibers is achieved by rotating one or more rollers at a faster rate than a roller located closer to the coagulation bath. In some embodiments, the roller speed is operated by electronic means such as a spinning control and a computer. In some embodiments, the computer control may include a graphical interface that displays and allows a user to adjust the spinning rate of any individual roller or group of rollers relative to another roller or group of rollers.

In some embodiments, the spinning control receives information from monitoring devices which characterize one or more physical properties of the silk fibers to adjust the speed of one or more rollers for further stretching, reduced stretching, and selective stretching. For example, if the desired physical property can be adjusted by increasing the desired stretch in a single bath, the spinning control may only increase the relative spin rates of rollers located at the end of a downstream bath (relative to other baths). In so doing, the stretching modification via a different spin rate is selectively tuned on only stretch bath.

In some embodiments, spinning speeds can be controlled between 0.1 mm/min to 1 m/min. In some embodiments, spinning speeds can be controlled between 0.1 mm/min to 10 m/min. In some embodiments, spinning speeds can be controlled between 0.1 mm/min to 5 m/min. In some embodiments, spinning speeds can be controlled between 0.1 mm/min to 2 m/min.

In some embodiments, the systems can include components that track tension measurements in the fibers. In such systems, the spinning control can dynamically respond to changes measured tensions in segments of the path of the fiber for quality control of the physical properties of the silk fiber.

In some embodiments, the fiber is stretched more than its original length in the coagulation bath. In some embodiments, the fiber is stretched between more than its original length in the coagulation bath and up to about 20 times that length. In some embodiments, the fiber is stretched between more than its original length in the coagulation bath and up to about 15 times that length. In some embodiments, the fiber is stretched between more than its original length in the coagulation bath and up to about 10 times that length. In some embodiments, the fiber is stretched between more than its original length in the coagulation bath and up to about 5 times that length. In some embodiments, the fiber is stretched between more than its original length in the coagulation bath and up to about 4 times that length. In some embodiments, the fiber is stretched between more than its original length in the coagulation bath and up to about 3.5 times that length. In some embodiments, the fiber is stretched between more than its original length in the coagulation bath and up to about 2.5 times that length. In some embodiments, the fiber is stretched between more than its original length in the coagulation bath and up to about 2.25 times that length. In some embodiments, the fiber is stretched between more than its original length in the coagulation bath and up to about 2 times that length. In some embodiments, the fiber is stretched more than its original length in the coagulation bath.

In some embodiments, a set of two or more rollers is referred to as a godet.

### Fiber Monitoring

Fibers prepared using the apparatus and its variants can also be characterized in real time monitoring. For example, the apparatus may also include a microscope for capturing real time images of the shape, orientation, thickness, and other observable properties. Other spectroscopic monitors may also be employed such as Raman and FTIR spectrometers.

### Fiber Weaving and Bundling

In some embodiments, the systems may include other fiber processing components such as for weaving and winding the fibers into yarns, fabrics, and other materials. A variety of textile weaving, twisting, and other handing can be applied to fibers using conventionally known components.

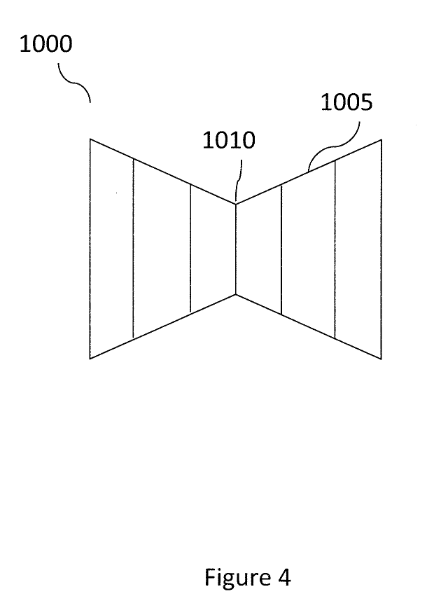

In some embodiments, some or all of the rollers may be shaped to guide the fibers along a specified path. For example, a roller 1000 is shown in FIG. 4 that has drum surface 1005. The drum surface 1005 may be v-shaped so that the fiber passes over the roller 1000 at point 1010 providing for finer control of the fiber location as it passes around (or past) the roller.

### EXAMPLES

For testing, each fiber is taken and mounted a stiff flat material like cardboard or used X-ray film with liquid Super Glue™. The diameter of the fibers is obtained by measuring each sample nine times along the length of sample using a light microscope. Fiber samples are fastened to a test bed equipped with a custom 10 g load cell (Transducer Techniques, Temecula, Calif.). Samples are pulled at either a quasi-static rate of 5 mm/min or at a quasi-dynamic rate of 1000 mm/min until breaking Data is exported and analyzed to obtain mechanical properties. Average stress is reported in units of MPa; average strain in units of mm/mm; toughness in units of MPa.

All baths were kept at room temperature unless otherwise specified. A blue PEEK tubing was used for extrusion needle (0.010″ ID) unless otherwise specified.

Fibers were processed quasi-static or quasi-dynamic speeds. Quasi-static speeds are relatively slow, i.e. at a rate of 0.5 mm per minute. Quasi-dynamic speeds are relatively fast, i.e. at a rate of 250-1000 mm per minute. Where no stretching takes place, all rollers and winding spool were run at substantially identical speeds such that the resulting fiber was not stretched a stretch bath or at any point. In some examples, one or more rollers downstream from other rollers are turned a faster rates to stretch a fiber, e.g. a “1.5×” stretch is accomplished by turning downstream rollers at a speed equal to about 150% of the speed of an upstream roller, i.e. resulting in a fiber stretch factor of 1.5. Similarly, a “2×” stretch is accomplished by turning downstream rollers at a speed equal to about 200% of the speed of an upstream roller, i.e. resulting in a fiber stretch factor of 2.

### Example 1

Dope was prepared using an 80:20 ratio of MaSp1 and MaSp2 at a concentration of 25% w/v (399.1 mg of MaSp1 and 101.2 mg of MaSp2) in an 80:20 ratio of HFIP and formic acid (1600 μL of HFIP and 400 μL of formic acid). A spinline was set up using the apparatus configuration shown in FIG. 1. Two, 24″ stretch baths were used. The first bath was filled with a 4:1 (80:20) ratio of methanol and deionized water (1600 mL methanol and 400 mL of DI water). The second bath was filled with deionized water only. The physical characteristics of the fibers using these parameters are shown in Table 1.

TABLE 1

| Stretching | No stretch | 1.5x each bath | 2x each bath |
|---|---|---|---|
| Speed | Quasi-static | Quasi-static | Quasi-static |
| Average Stress (MPa) | 14.3 | 164.1 | 257.7 |
| Average Strain (mm/mm) | 0.015 | 0.662 | 0.401 |
| Toughness (MPa) | 0.092 | 92.3 | 84.4 |

### Example 2

Dope was prepared using a 1:1 ratio of MaSp1 and MaSp2 at a concentration of 25% w/v (399.1 mg of MaSp1 and 101.2 mg of MaSp2) in an 80:20 ratio of HFIP and formic acid (1600 μL of HFIP and 400 μL of formic acid). A spinline was set up using the apparatus configuration shown in FIG. 1. Two, 24″ stretch baths were used. The first bath was filled with a 4:1 (70:30) ratio of isopropanol (IPA) and deionized water (1600 mL IPA and 400 mL of DI water). The second bath was filled with deionized water only. The physical characteristics of the resulting fibers are shown in Table 2.

TABLE 2

| Stretching | 1.5x each bath | 2x each bath |
|---|---|---|
| Speed | Quasi-static | Quasi-static |
| Aver Max Stress | 157.5 | 240.5 |
| Average Max Strain | 1.01 | 0.407 |
| Toughness | 132.2 | 81.1 |

### Example 3

Dope was prepared using a 100% MaSp2 at a concentration of 25% w/v (500.7 mg MaSp2) in an 80:20 ratio of HFIP and acetic acid (1600 μL of HFIP and 400 μL of acetic acid). A spinline was set up using the apparatus configuration shown in FIG. 1. Two, 24″ stretch baths were used. The first bath was filled with a 4:1 (70:30) ratio of ispropanol and deionized water (1600 mL IPA and 400mL of DI water). The second bath was filled with deionized water only. The physical characteristics of the fibers using these parameters are shown in Table 3.

TABLE 3

| Stretching | 2x each bath | 2x each bath | 2x bath 1/ | 2x bath 1/ |
|---|---|---|---|---|
| | | | 2.5x bath 2 | 2.5x bath 2 |
| Speed | Quasi-static | Quasi- | Quasi-static | Quasi- |
| | | dynamic | | dynamic |
| Average Max | 231.7 | 290.1 | 288.5 | 347.6 |
| Stress | | | | |
| Average Max | 0.3 | 0.35 | 0.22 | 0.24 |
| Strain | | | | |
| Toughness | 56.2 | 80.6 | 49.6 | 65.9 |

### Example 4

Dope was prepared using an 80:20 ratio of MaSp1 and MaSp2 at a concentration of 25% w/v (400.2 mg of MaSp1 and 101.2 mg of MaSp2) in an 90:10 ratio of HFIP and propionic acid (1800 μL of HFIP and 200 μL of propionic acid). A spinline was set up using the apparatus configuration shown in FIG. 1. Two, 24″ stretch baths were used. The first bath was filled with a 4:1 (80:20) ratio of methanol and deionized water (1600 mL methanol and 400 mL of DI water). The second bath was filled with deionized water only. The physical characteristics of the fibers using these parameters are shown in Table 4.

TABLE 4

| Stretching | 2x each | 2x each | 2.5x each | 2.5x each |
|---|---|---|---|---|
| | bath | bath | bath | bath |
| Speed | Quasi-static | Quasi- | Quasi-static | Quasi- |
| | | dynamic | | dynamic |
| Average Max | 208.6 | 278.7 | 318.6 | 374.8 |
| Stress | | | | |
| Average Max | 0.41 | 0.53 | 0.25 | 0.31 |
| Strain | | | | |
| Toughness | 72.4 | 118.0 | 63.8 | 91.8 |

### Example 5

Dope was prepared using 100% MaSp1 of 20% w/v (499.4 mg of MaSp1) in an 80:20 ratio of HFIP and formic acid (2000 μL of HFIP and 500 μL of formic acid). A spinline was set up using the apparatus configuration shown in FIG. 1. Two, 24″ stretch baths were used. The first bath was filled with a 7:4 (70:30) ratio of isopropanol and deionized water (1400 mL IOPA and 600 mL of DI water). The second bath was filled with deionized water only. The physical characteristics of the fibers using these parameters are shown in Table 5.

TABLE 5

| Stretching | 1.5x each | 1.5x each | 2x each | 2x each |
|---|---|---|---|---|
| | bath | bath | bath | bath |
| Speed | Quasi-static | Quasi- | Quasi-static | Quasi- |
| | | dynamic | | dynamic |
| Average Max | 104.8 | 142.7 | 145.2 | 192.5 |
| Stress | | | | |
| Average Max | 0.78 | 0.76 | 0.36 | 0.44 |
| Strain | | | | |
| Toughness | 63.7 | 95.2 | 44.1 | 74.8 |

### Example 6

Dope was prepared using an 20:80 ratio of MaSp1 and MaSp2 at a concentration of 25% w/v (103 mg of MaSp1 and 399.3 mg of MaSp2) in an 80:20 ratio of HFIP and formic acid (2000 μL of HFIP and 500 μL of formic acid). A spinline was set up using the apparatus configuration shown in FIG. 1. Two, 24″ stretch baths were used. The first bath was filled with a 4:1 (80:20) ratio of methanol and deionized water (1600 mL methanol and 400 mL of DI water). The second bath was filled with deionized water only. The physical characteristics of the fibers using these parameters are shown in Table 6.

TABLE 6

| Stretching | 1.5x each | 1.5x each | 2x each | 2x each |
|---|---|---|---|---|
| | bath | bath | bath | bath |
| Speed | Quasi-static | Quasi- | Quasi-static | Quasi- |
| | | dynamic | | dynamic |
| Average Max | 136.4 | 164.8 | 182.5 | 215.9 |
| Stress | | | | |
| Average Max | 0.68 | 0.82 | 0.25 | 0.2 |
| Strain | | | | |
| Toughness | 77.6 | 110.3 | 37.3 | 34.1 |

### Example 7

Dope was prepared using an 80:20 ratio of MaSp1 and MaSp2 at a concentration of 20% w/v (320 mg of MaSp1 and 80.6 mg of MaSp2) in an 70:15:15 ratio of HFIP, formic acid, and acetic acid (1400 μL of HFIP, 300 μL of formic acid, and 300 μL of acetic acid). A spinline was set up using the apparatus configuration shown in FIG. 1. Two, 24″ stretch baths were used. The first bath was filled with a 4:1 (80:20) ratio of methanol and deionized water (1600 mL methanol and 400 mL of DI water). The second bath was filled with deionized water only. The physical characteristics of the fibers using these parameters are shown in Table 7.

TABLE 7

| Stretching | 1.5x each bath | 2x each bath |
|---|---|---|
| Speed | Quasi-static | Quasi-static |
| Average Max Stress | 147.3 | 207.5 |
| Average Max Strain | 0.55 | 0.32 |
| Toughness | 71.2 | 58.5 |

### Example 8

Dope was prepared using an 80:20 ratio of MaSp1 and MaSp2 at a concentration of 20% w/v (320.8 mg of MaSp1 and 80.8 mg of MaSp2) in an 80:20 ratio of HFIP and formic acid (1600 μL of HFIP and 400 μL of formic acid). A spinline was set up using the apparatus configuration shown in FIG. 1. Two, 36″ stretch baths were used. The first bath was filled with a 2M ammonium sulfate in deionized water (264.28 mg (NH₄)₂SO₄ in 2 L of DI water) and kept at a temperature of 62° C. The second bath was filled with 1:1 ratio of isopropanol and deionized water (1 L each). The physical characteristics of the fibers using these parameters are shown in Table 8.

TABLE 8

| Stretching | 1.5x each bath | 1.5x first bath/ |
|---|---|---|
| | | 2x second bath |
| Speed | Quasi-static | Quasi-static |
| Average Max Stress | 118.3 | 243.6 |
| Average Max Strain | 0.09 | 0.21 |
| Toughness | 9.5 | 44 |

### Example 9

Dope was prepared using an 80:20 ratio of MaSp1 and MaSp2 at a concentration of 20% w/v (320.1 mg of MaSp1 and 80 mg of MaSp2) in an 80:20 ratio of HFIP and formic acid (1600 μL of HFIP and 400 μL of formic acid). A spinline was set up using the apparatus configuration shown in FIG. 1. Two, 16″ stretch baths were used with heat lamps located 20 cm above the span between the second and third roller of each set of rollers maintaining an air temperature of 50° C. at 20 cm away from the lamp (the position of the fiber). The first bath was filled with a 2M ammonium sulfate in deionized water (264.28 mg (NH₄)₂SO₄ in 2 L of DI water). The second bath was filled with deionized water only. The physical characteristics of the fibers using these parameters are shown in Table 9.

TABLE 9

| Stretching | 2x bath 1/ | 2x each bath |
|---|---|---|
| | 1.5x bath 2 | |
| Speed | Quasi-static | Quasi-static |
| Average Max Stress | 189.7 | 203.1 |
| Average Max Strain | 0.19 | 0.22 |
| Toughness | 33.1 | 38.8 |

### Example 10

Dope was prepared using an 80:20 ratio of MaSp1 and MaSp2 at a concentration of 20% w/v (320.1 mg of MaSp1 and 80 mg of MaSp2) in an 80:20 ratio of HFIP and formic acid (1600 μL of HFIP and 400 μL of formic acid). A spinline was set up using the apparatus configuration shown in FIG. 2. Two, 16″ baths were used. The first bath was filled with a 2M ammonium sulfate in deionized water (264.28 mg (NH₄)₂SO₄ in 2 L of DI water). The second bath was filled with deionized water only. The physical characteristics of the fibers using these parameters are shown in Table 10.

TABLE 10

| Stretching | No stretch | 2x first bath/ | 3x first bath/ | 4x first bath/ |
|---|---|---|---|---|
| | | lx second | lx second | lx second |
| | | bath | bath | bath |
| Speed | Quasi-static | Quasi-static | Quasi-static | Quasi-static |
| Average Max | 77.6 | 109.8 | 145.5 | 173.4 |
| Stress | | | | |
| Average Max | 0.03 | 0.6 | 0.55 | 0.41 |
| Strain | | | | |
| Toughness | 1.32 | 54.8 | 65.9 | 60.6 |

### Example 11

Dope was prepared using an 80:20 ratio of MaSp1 and MaSp2 at a concentration of 20% w/v (640.6 mg of MaSp1 and 159.9 mg of MaSp2) in an 80:20 ratio of HFIP and formic acid (3200 μL of HFIP and 800 μL of formic acid). A spinline was set up using the apparatus configuration shown in FIG. 2. Two, 16″ baths were used. A heat lamp was located 20 cm above fiber between the second bath and a winder maintaining a temperature of about 50° C. at the location of the fiber. The first bath was filled with an 80:20 mixture of isopropanol and water (1600 mL of IPA and 400 mL of deionized water), and the second bath was filled with a 10:90 ratio of isopronol and water (200 mL of IPA and 1800 mL of deionized water). The physical characteristics of the fibers using these parameters are shown in Table 11.

TABLE 11

| Stretching | No stretch | 2x first bath/ | 3x first bath/ |
|---|---|---|---|
| | | lx second bath | lx second bath |
| Speed | Quasi-static | Quasi-static | Quasi-static |
| Average Max Stress | 84.17 | 108.9 | 141.1 |
| Average Max Strain | 0.02 | 0.34 | 0.66 |
| Toughness | 0.84 | 34.4 | 74.6 |

### Example 12

Dope was prepared using an 80:20 ratio of MaSp1 and MaSp2 at a concentration of 20% w/v (640.6 mg of MaSp1 and 159.9 mg of MaSp2) in an 80:20 ratio of HFIP and formic acid (3200 μL of HFIP and 800 μL of formic acid). A spinline was set up using the apparatus configuration shown in FIG. 3. A single, 16″ bath was used. The first bath was filled with a 50:50 mixture of isopropanol and deionized water (1 L each), and the second bath was filled with a 10:90 ratio of isopronol and water (200 mL of IPA and 1800 mL of deionized water). The physical characteristics of the fibers using these parameters are shown in Table 12.

TABLE 12

| Stretching | 1.5x | 2.5x | 3.5x |
|---|---|---|---|
| Speed | Quasi-static | Quasi-static | Quasi-static |
| Average Max Stress | 51.7 | 59.3 | 84.3 |
| Average Max Strain | 1.53 | 1.43 | 0.44 |
| Toughness | 62.7 | 61.6 | 31 |

What is claimed is:

1. An apparatus for producing silk fibers, comprising:
an extruder;
a first coagulation bath comprising a coagulating agent selected from the group consisting of an organic alcohol, high salt aqueous solution, and mixtures of the same;
an adjustable, mounting frame;
a plurality of rollers located on the frame; and
a first stretch bath located between at least two rollers and comprising an organic alcohol, an aqueous salt, or mixtures of the same.

2. The apparatus of claim 1, wherein the plurality of rollers comprises:
a first set of rollers comprising at least three rollers, wherein each roller is located on the frame; and
a second set of rollers comprising at least three rollers, wherein each roller is located on the frame.

3. The apparatus of claim 1, further comprising a second stretch bath comprising an organic alcohol, an aqueous salt, or mixtures of the same.

4. The apparatus of claim 1, further comprising one or more monitoring devices for inspecting properties of silk fibers passing by the one or more monitoring devices.

5. The apparatus of claim 1, further comprising a spool onto which fibers passing through the apparatus may be wound.

6. The apparatus of claim 1, further comprising one or more heat lamps.

7. The apparatus of claim 1, wherein at least two rollers are immersed in the first stretch bath.

8. The apparatus of claim 1, wherein each roller has a drum surface, and at least one roller has a v-shaped drum surface.

9. The apparatus of claim 1, further comprising a plurality of motors, each motor connected to a roller.

10. The apparatus of claim 1, further comprising a spinning control capable of regulating the rotating speed of one roller relative to another roller.

11. A method of making a silk fiber, comprising:
extruding a spin dope comprising recombinant spider silk protein into a coagulation bath comprising an organic alcohol to form a silk fiber;
winding the fiber through a plurality of adjustable rollers and a first stretch bath, wherein the a first set of rollers introduces the silk fiber into the stretch bath and a second set of rollers removes the silk fiber from the stretch bath, and wherein the rollers may be adjustably located relative to one another on an adjustable, mounting frame;
stretching the silk fiber in the stretch bath by rotating one of the rollers faster than another roller.

12. The method of claim 11, wherein the plurality of rollers comprises a first set three rollers and a second set of three rollers.

13. The method of claim 11, further comprising stretching the silk fiber in a second stretch bath.

14. The method of claim 11, further comprising monitoring physical characteristics of the silk fiber.

15. The method of claim 11, further comprising collecting the fiber onto a spool.

16. The method of claim 11, further comprising heating the fiber with one or more heat lamps.

17. The method of claim 11, wherein each roller has a drum surface, and at least one roller has a v-shaped drum surface.

18. The method of claim 11, further comprising using a spinning control capable of regulating the rotating speed of one roller relative to another roller.

19. The method of claim 11, further comprising air-stretching the silk fiber.
